(19) United States
(12) Patent Application Publication
(10) Pub. No.: US 2026/0034892 A1
(43) Pub. Date: Feb. 5, 2026

(54) Electric Vehicle with Optimized Regenerative Braking System

(71) Applicant: Tactile Mobility Ltd., Haifa (IL)

(72) Inventors: Boaz Mizrachi, Haifa (IL); Stas Shapira, Haifa (IL); Michael Zack, Haifa (IL)

(73) Assignee: Tactile Mobility Ltd., Haifa (IL)

(21) Appl. No.: 18/795,115

(22) Filed: Aug. 5, 2024

(51) Int. Cl. B60L 7/18; B60L 15/20

(52) U.S. Cl. CPC B60L 7/18; B60L 15/2009; B60L 2240/12

(57) ABSTRACT

There is provided a method for adaptive regenerative braking, the method includes obtaining grip information that is indicative of a grip associated with an electrical vehicle during a grip evaluation period; determining, based on the grip information, a value of a regenerative braking parameter; and sending to a regenerative braking unit of the vehicle an instruction to apply during a portion of the regenerative braking period, the regenerative braking parameter.

### BACKGROUND OF THE INVENTION

Electric vehicles (EVs) utilize regenerative braking to recover kinetic energy during deceleration, converting it into electrical energy that can be stored in the battery. Traditional systems apply a fixed amount of regenerative torque to the wheels, often limited to prevent wheel slip under poor traction conditions. This conservative approach may result in less energy recovery than possible under current road and tire grip conditions.

### SUMMARY

There are provided methods, non-transitory computer readable media and computerized systems as illustrated in the specification.

### BRIEF DESCRIPTION OF THE DRAWINGS

The subject matter that is regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawing in which:

FIG. 1A illustrates an example of a method for optimizing vehicle braking efficiency through the utilization of grip data;

FIG. 1B illustrates an example of an initial assessment of vehicle grip to inform adaptive braking;

FIG. 1C illustrates an example of a process of updating braking parameters using additional grip information;

FIG. 1D illustrates an example of an implementation of braking parameters across various braking intervals;

FIG. 2 illustrates an example of a method for monitoring and managing the health of electric vehicle brakes;

FIG. 3A illustrates an example of a method;

FIG. 3B illustrates an example of a method;

FIG. 4A illustrates an example of a method;

FIG. 4B illustrates an example of a method;

FIG. 5 illustrates an example of a system;

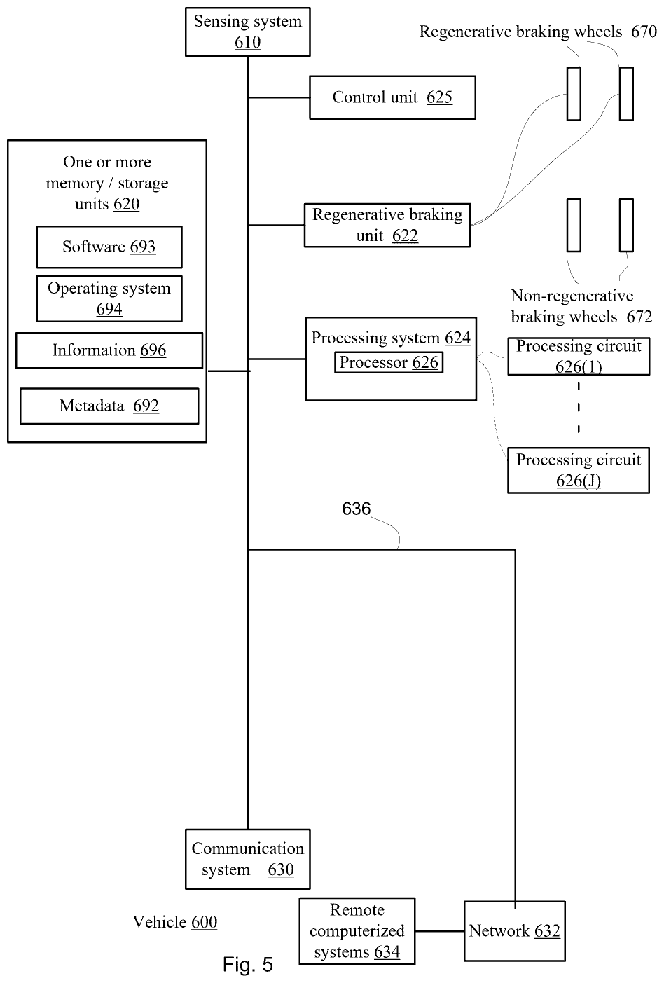

FIG. 6 illustrates examples of timing diagrams; and

FIG. 7 illustrates examples of software and information elements stored in the one or more memory/storage units of FIG. 5.

### DETAILED DESCRIPTION OF THE DRAWINGS

### Electric Vehicle with Optimized Regenerative Braking System

In accordance with embodiments, a method, a non-transitory computer readable unit and a system is provided for adaptive regenerative braking in an electric vehicle. The method includes obtaining grip information indicative of the vehicle's grip during a grip evaluation period and determining a value for a regenerative braking parameter based on this grip information. The regenerative braking parameter is then applied during at least a portion of the regenerative braking period. The grip evaluation period may start at or in close timing proximity to the beginning of adaptive regenerative braking, or it may end before the beginning of adaptive regenerative braking. Grip information can be generated based on radial speeds of both regenerative braking wheels and non-regenerative braking wheels of the electric vehicle. Additionally, the method may involve obtaining further grip information during an additional grip evaluation period to determine and apply an additional value of the regenerative braking parameter during another portion of the regenerative braking period. Furthermore, driving pattern information indicative of an expected driving pattern of the vehicle or the driver may also be obtained, and the determination of the regenerative braking parameter value may be based on this information as well.

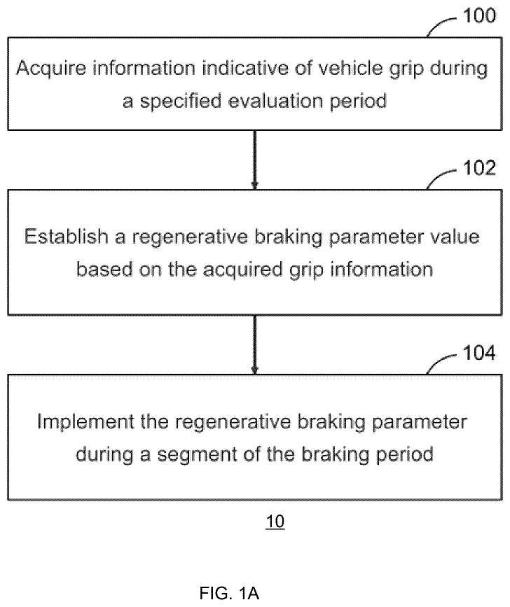

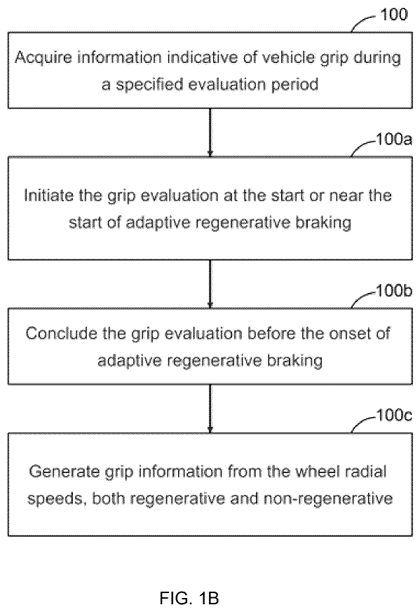

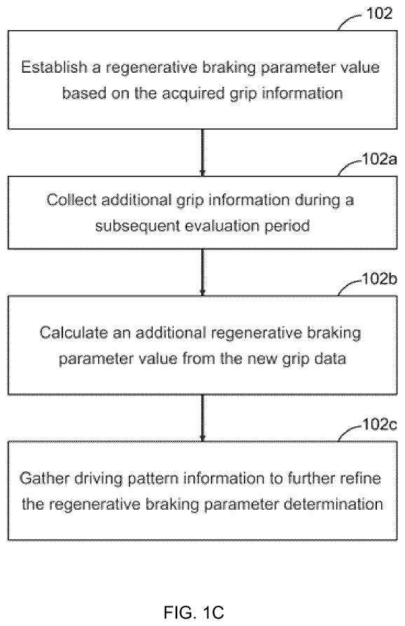

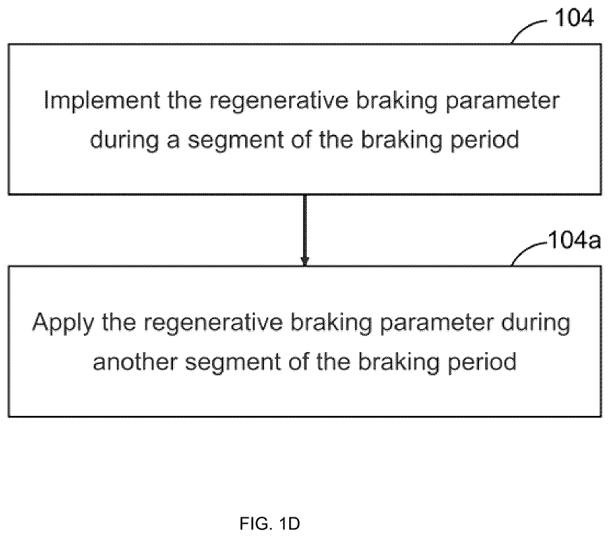

FIG. 1 illustrates method 10 that starts by step 100 that includes obtaining grip information that is indicative of a grip associated with an electric vehicle during a grip evaluation period. This grip information helps in determining the value of a regenerative braking parameter. The grip evaluation period can start at the beginning of the adaptive regenerative braking or following the beginning of the adaptive regenerative braking and in timing proximity to the beginning of the adaptive regenerative braking (sub-step 100-a). Alternatively, the grip evaluation period can end before the beginning of the adaptive regenerative braking (sub-step 100-b). The grip information is generated based on the radial speeds of regenerative braking wheels of an electric vehicle and on the radial speeds of non-regenerative braking wheels of the electric vehicle (sub-step 100-c). The grip information is used to determine the grip associated with an electric vehicle during a grip evaluation period.

This information is used to prevent the vehicle from slipping and to perform regenerative braking. The electric vehicle performs regenerative braking by applying a torque on the front wheels. The value of the torque is determined regardless of the current grip and is set to a minimal amount of torque that will prevent the vehicle from slipping under the worst grip circumstances.

Therefore, the energy gained during regenerative braking may be much lower than the energy gained under the actual grip of the vehicle. The grip evaluation period is defined to start at the beginning of the adaptive regenerative braking or following the beginning of the adaptive regenerative braking and in timing proximity to the beginning of the adaptive regenerative braking. This period defines the time frame for obtaining grip information. The grip evaluation period can also end before the beginning of the adaptive regenerative braking, which defines the end of the time frame for obtaining grip information.

The grip information is generated based on the radial speeds of regenerative braking wheels and non-regenerative braking wheels of the electric vehicle. This information is used to generate grip information for determining the regenerative braking parameter. The torque value is determined during regenerative braking, which is set to a minimal level to prevent vehicle slippage under poor grip conditions. The value of the torque is determined regardless of the current grip and is set to a minimal amount of torque that will prevent the vehicle from slipping under the worst grip circumstances. Therefore, the energy gained during regenerative braking may be much lower than the energy gained under the actual grip of the vehicle.

In step 100-a, the grip evaluation period starts at a beginning of the adaptive regenerative braking or following the beginning of the adaptive regenerative braking and in timing proximity to the beginning of the adaptive regenerative braking. This step involves the grip evaluation period and the Electric vehicle. The grip evaluation period is for determining the grip information, which is indicative of a grip associated with an electrical vehicle during this period. The grip evaluation period starts at the beginning of the adaptive regenerative braking or shortly after, ensuring that the grip information is relevant and timely for the braking process.

The Electric vehicle performs regenerative braking by applying a torque on the front wheels. The value of the torque is determined regardless of the current grip and is set to a minimal amount of torque that will prevent the vehicle from slipping under the worst grip circumstances. This ensures that the vehicle maintains stability and safety during braking. The process by which the electric vehicle recovers energy during braking by applying torque to the front wheels. Therefore, the energy gained during regenerative braking may be much lower than the energy gained under the actual grip of the vehicle. In summary, step 100-a establishes the timing for the grip evaluation period, which is for obtaining accurate grip information. This information is used to determine the regenerative braking parameter, ensuring that the Electric vehicle can perform regenerative braking effectively and safely by applying the appropriate torque to the front wheels.

In sub-step 100-b, the grip evaluation period ends before a beginning of the adaptive regenerative braking. This sub-step involves the grip evaluation period and the Electric vehicle. The grip evaluation period defines the end of the time frame for obtaining grip information, which is indicative of a grip associated with an electrical vehicle during a grip evaluation period. This grip information is used to determine a value of a regenerative braking parameter. The grip evaluation period defines the end of the time frame for obtaining grip information.

According to an embodiment, the grip estimation is executed in a continuous manner throughout the entire regenerative braking.

The regenerative braking process involves the electric vehicle performing regenerative braking by applying a torque on the front wheels. The value of the torque is determined regardless of the current grip and is set to a minimal amount of torque that will prevent the vehicle from slipping under the worst grip circumstances. Therefore, the energy gained during regenerative braking may be much lower than the energy gained under the actual grip of the vehicle.

The grip evaluation period indicates the process by which the electric vehicle recovers energy during braking by applying torque to the front wheels. This process ensures that the vehicle does not slip under poor grip conditions by setting the torque value to a minimal level. The grip evaluation period includes its start and end times, which are for determining when to obtain grip information and how to apply the regenerative braking parameter effectively.

In summary, sub-step 100-b emphasizes the grip evaluation period ending before the beginning of adaptive regenerative braking. This ensures that the grip information is accurately obtained and used to determine the regenerative braking parameter, which is for the efficient and safe operation of the electric vehicle's regenerative braking system.

In step 100-c, the grip information is generated based on radial speeds of regenerative braking wheels of an electric vehicle and on radial speeds of non-regenerative braking wheels of the electric vehicle. The grip information is for determining the value of the regenerative braking parameter, which is for the adaptive regenerative braking system. The grip information is indicative of a grip associated with an electrical vehicle during a grip evaluation period. This information is generated to determine a value of a regenerative braking parameter. The purpose of generating grip information based on radial speeds is to generate grip information for determining the regenerative braking parameter.

This process involves obtaining the radial speeds of both regenerative braking wheels and non-regenerative braking wheels of the electric vehicle. The electric vehicle performs regenerative braking by applying a torque on the front wheels. The value of the torque is determined regardless of the current grip and is set to a minimal amount of torque that will prevent the vehicle from slipping under the worst grip circumstances. This ensures that the vehicle maintains stability and safety during braking. However, this approach may result in lower energy recovery during regenerative braking compared to the potential energy that could be gained under the actual grip conditions of the vehicle.

The grip information generated from the radial speeds of the wheels is used to set the torque value for regenerative braking. This value is for initiating regenerative braking, which helps slow down the vehicle and generate energy. The minimal amount of torque is determined to prevent vehicle slippage under poor grip conditions, ensuring safety and stability. In summary, step 100-c involves generating grip information based on the radial speeds of both regenerative and non-regenerative braking wheels of the electric vehicle. This information is used to determine the value of the regenerative braking parameter, which is set to a minimal amount of torque to prevent vehicle slippage under the worst grip circumstances. This process ensures the safety and stability of the vehicle during regenerative braking while aiming to maximize energy recovery.

In step 102, the process involves determining, based on the grip information, a value of a regenerative braking parameter. This step is for setting the regenerative braking parameter based on the grip information obtained earlier. The regenerative braking parameter is for controlling the regenerative braking process, which aims to slow down the vehicle and generate energy.

The regenerative braking parameter is determined to set the torque value and initiate regenerative braking. The value of the torque is determined regardless of the current grip and is set to a minimal amount of torque that will prevent the vehicle from slipping under the worst grip circumstances. This ensures that the vehicle maintains stability and safety during braking. In sub-step 102-a, additional grip information is obtained, which is indicative of the grip associated with the electrical vehicle during an additional grip evaluation period.

This additional grip information is used to determine an additional value of the regenerative braking parameter. The purpose of obtaining this additional grip information is to perform regenerative braking more effectively by adjusting the torque value based on the updated grip conditions. In sub-step 102-b, the additional value of the regenerative braking parameter is determined based on the additional grip information. This additional value is for setting the torque value and initiating regenerative braking under the new grip conditions. The goal is to gain more energy during regenerative braking by applying a torque that is optimized for the current grip conditions. In sub-step 102-c, driving pattern information is obtained, which is indicative of an expected driving pattern of at least one of the electrical vehicle and a driver of the electrical vehicle. This driving pattern information influences the determination of the value of the regenerative braking parameter.

The value of the torque is determined based on this driving pattern information to ensure that the regenerative braking process is optimized for the expected driving conditions. Overall, step 102 and its sub-steps ensure that the regenerative braking parameter is accurately determined based on grip information, additional grip information, and driving pattern information. This allows the electric vehicle to perform regenerative braking more effectively, gaining more energy and maintaining stability and safety during braking.

In sub-step 102-a, the process involves obtaining additional grip information that is indicative of the grip associated with the electrical vehicle during an additional grip evaluation period. This additional grip information is for determining the grip associated with the vehicle during this specific period. The purpose of obtaining this additional grip information is to perform regenerative braking, which is to slow down the vehicle and generate energy. The additional grip information is used to determine an additional value of the regenerative braking parameter. This parameter is for setting the torque value and initiating regenerative braking. The value of the torque is determined regardless of the current grip and is set to a minimal amount of torque that will prevent the vehicle from slipping under the worst grip circumstances.

This ensures that the vehicle maintains stability and safety during braking. The electric vehicle performs regenerative braking by applying a torque on the front wheels. The value of the torque is determined based on the additional grip information obtained during the additional grip evaluation period. This process is designed to gain more energy during regenerative braking, as the energy gained may be much lower than the energy gained under the actual grip of the vehicle. Therefore, there is a growing need to optimize the energy recovery during regenerative braking. The additional grip information is indicative of the grip associated with the electrical vehicle during the additional grip evaluation period. This information is used to determine an additional value of the regenerative braking parameter, which is for setting the torque value and initiating regenerative braking. The value of the torque is determined based on the additional grip information, ensuring that the vehicle maintains stability and safety during braking. In summary, sub-step 102-a involves obtaining additional grip information during an additional grip evaluation period to determine an additional value of the regenerative braking parameter. This process is for optimizing the energy recovery during regenerative braking and ensuring the stability and safety of the vehicle. The value of the torque is set to a minimal amount to prevent the vehicle from slipping under the worst grip circumstances, thereby enhancing the efficiency and effectiveness of the regenerative braking system.

In sub-step 102-b, the process involves determining, based on the additional grip information, an additional value of the regenerative braking parameter. The additional grip information is indicative of the grip associated with the electrical vehicle during an additional grip evaluation period. This step is for setting an additional value for the regenerative braking parameter, which is for optimizing the regenerative braking process. The regenerative braking parameter is determined to set the torque value and initiate regenerative braking. The value of the torque is determined regardless of the current grip and is set to a minimal amount of torque that will prevent the vehicle from slipping under the worst grip circumstances.

This ensures that the vehicle can perform regenerative braking effectively by applying a torque on the front wheels, thereby slowing down the vehicle and generating energy. The additional value of the regenerative braking parameter is determined to gain more energy during the regenerative braking process. This is particularly important because the energy gained during regenerative braking may be much lower than the energy gained under the actual grip of the vehicle. Therefore, there is a growing need to gain more energy during regenerative braking, and determining an additional value of the regenerative braking parameter based on additional grip information helps achieve this goal.

The additional grip information is used to set the torque value, which is for the regenerative braking process. The value of the torque is determined based on the additional grip information to ensure that the vehicle can perform regenerative braking effectively, even under varying grip conditions. This helps in optimizing the energy recovery during braking and ensures that the vehicle can generate the maximum possible energy during the regenerative braking period. In summary, sub-step 102-b involves determining an additional value of the regenerative braking parameter based on additional grip information. This step is for optimizing the regenerative braking process by setting the torque value to prevent vehicle slippage and maximize energy recovery during braking. The additional grip information helps in setting the torque value effectively, ensuring that the vehicle can perform regenerative braking efficiently under varying grip conditions.

In step 102-c, the process involves obtaining driving pattern information indicative of an expected driving pattern of at least one of the electrical vehicle and a driver of the electrical vehicle. This step informs the determination of the value of the regenerative braking parameter. The driving pattern information is used to influence the setting of the torque value during regenerative braking.

The value of the torque is determined regardless of the current grip and thus is set to a minimal amount of torque that will prevent the vehicle from slipping under the worst grip circumstances. This ensures that the regenerative braking system can adapt to different driving patterns, thereby optimizing the energy recovery process. The driving pattern information is indicative of an expected driving pattern of at least one of the electrical vehicle and a driver of the electrical vehicle. This information is used to determine the value of the regenerative braking parameter, which is for setting the torque value during regenerative braking. The torque value is set to a minimal level to prevent vehicle slippage under poor grip conditions.

This is particularly important because the value of the torque is determined regardless of the current grip, ensuring that the vehicle does not slip even under the worst grip circumstances. The torque value is determined during regenerative braking. The value of the torque is set to a minimal amount to prevent the vehicle from slipping under poor grip conditions. This is achieved by considering the driving pattern information, which influences the determination of the regenerative braking parameter. The regenerative braking system applies a torque on the front wheels, and the value of this torque is for preventing vehicle slippage and optimizing energy recovery.

In summary, step 102-c involves obtaining driving pattern information to inform the determination of the regenerative braking parameter. This parameter is used to set the torque value during regenerative braking, ensuring that the vehicle does not slip under poor grip conditions. The driving pattern information is indicative of an expected driving pattern of the electrical vehicle and its driver, and it plays a role in optimizing the energy recovery process during regenerative braking. In step 104, the process involves applying, during a portion of the regenerative braking period, the regenerative braking parameter. This step is for the effective implementation of adaptive regenerative braking in an electric vehicle. The regenerative braking parameter is determined based on grip information, which is indicative of the grip associated with the electric vehicle during a grip evaluation period. The grip information is generated based on the radial speeds of regenerative braking wheels and non-regenerative braking wheels of the electric vehicle. The regenerative braking parameter is applied to control the regenerative braking during a portion of the regenerative braking period.

This application is to gain more energy during regenerative braking by applying a torque on the front wheels. The value of the torque is determined regardless of the current grip and is set to a minimal amount of torque that will prevent the vehicle from slipping under the worst grip circumstances. This ensures that the energy gained during regenerative braking is maximized under the actual grip conditions of the vehicle. Additionally, the regenerative braking parameter is applied during an additional portion of the regenerative braking period.

This involves obtaining additional grip information that is indicative of the grip associated with the electric vehicle during an additional grip evaluation period. Based on this additional grip information, an additional value of the regenerative braking parameter is determined and applied. This further enhances the energy recovery process during regenerative braking. The electric vehicle performs regenerative braking by applying a torque on the front wheels. The value of the torque is determined based on the grip information and additional grip information, ensuring that the vehicle does not slip under poor grip conditions. The torque value is determined during regenerative braking, which is set to a minimal level to prevent vehicle slippage under poor grip conditions. Therefore, the energy gained during regenerative braking may be much lower than the energy gained under the actual grip of the vehicle, highlighting the need to gain more energy during regenerative braking. In summary, step 104 involves the application of the regenerative braking parameter during a portion and an additional portion of the regenerative braking period. This process is for maximizing energy recovery during regenerative braking while ensuring vehicle stability under varying grip conditions.

In step 104-a, the process involves applying, during an additional portion of the regenerative braking period, the regenerative braking parameter. This step is for the effective functioning of the regenerative braking system in an electric vehicle. The regenerative braking parameter is applied to control the regenerative braking during a portion of the regenerative braking period. This action is intended to gain more energy, applying a torque, and performing regenerative braking to slow down the vehicle and generate energy. The regenerative braking parameter is a critical part of this process.

It is determined based on grip information and is set to a minimal amount of torque that will prevent the vehicle from slipping under the worst grip circumstances. This ensures that the energy gained during regenerative braking is maximized under the actual grip conditions of the vehicle. The value of the torque is determined regardless of the current grip, which means it is set to a minimal amount to prevent vehicle slippage under poor grip conditions. This is for the safety and efficiency of the regenerative braking system. The electric vehicle performs regenerative braking by applying a torque on the front wheels. The value of the torque is determined based on the grip information obtained during the grip evaluation period.

This grip information is indicative of the grip associated with the electrical vehicle during the grip evaluation period. The grip evaluation period starts at the beginning of the adaptive regenerative braking or following the beginning of the adaptive regenerative braking and in timing proximity to the beginning of the adaptive regenerative braking. It ends before the beginning of the adaptive regenerative braking. The grip information is generated based on the radial speeds of regenerative braking wheels and non-regenerative braking wheels of the electric vehicle.

Additionally, the process involves obtaining additional grip information that is indicative of the grip associated with the electrical vehicle during an additional grip evaluation period. This additional grip information is used to determine an additional value of the regenerative braking parameter. The additional value of the regenerative braking parameter is also set to a minimal amount of torque to prevent vehicle slippage under poor grip conditions.

This ensures that the energy gained during regenerative braking is maximized under the actual grip conditions of the vehicle.

In summary, step 104-a involves the application of the regenerative braking parameter during an additional portion of the regenerative braking period. This step is for maximizing the energy gained during regenerative braking while ensuring the safety and efficiency of the electric vehicle. The process involves obtaining grip information, determining the regenerative braking parameter, and applying the parameter to control the regenerative braking.

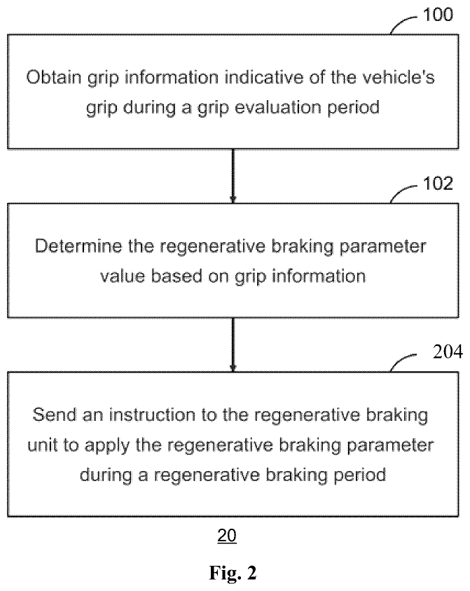

According to an embodiment, the method includes sending an instruction to regenerative braking unit—and not applying the regenerative braking parameter during a portion of the regenerative braking period—this is illustrated by method 20 of FIG. 2 and step 204 instead of step 104 of FIG. 1. Any reference to the applying of the regenerative braking parameter should be applied, nutates mutandis to the applying of the regenerative braking parameter.

In step 204, the process involves sending an instruction to a regenerative braking unit of the vehicle to apply a regenerative braking parameter during a portion of the regenerative braking period. This step is for the adaptive regenerative braking method, as it ensures that the regenerative braking parameter, which has been determined based on grip information, is effectively utilized to optimize energy recovery and vehicle stability. The regenerative braking unit is responsible for receiving the instruction to apply the regenerative braking parameter. The purpose of this attribute is to describe the function of the electric vehicle in utilizing regenerative braking to apply torque to the front wheels, which is a method for recovering energy that would otherwise be lost during braking. The regenerative braking unit's role is to initiate regenerative braking, which helps to slow down the vehicle and generate energy. The regenerative braking parameter is a value that is set based on grip information. The purpose of this attribute is to specify how the torque is determined and applied to ensure vehicle stability by preventing slippage even in the worst grip conditions, which is for safety. The value of the torque is determined regardless of the current grip and thus is set to a minimal amount of torque that will prevent the vehicle from slipping under the worst grip circumstances. This conservative approach ensures safety over energy recovery efficiency, highlighting the limitation of the regenerative braking system in terms of energy recovery and expressing the need for improvements to increase the amount of energy regained, especially under actual grip conditions. The regenerative braking period is the time frame during which the regenerative braking parameter is applied. The purpose of this attribute is to describe the function of the electric vehicle in utilizing regenerative braking to apply torque to the front wheels, which is a method for recovering energy that would otherwise be lost during braking. During this period, the regenerative braking parameter is applied to optimize energy recovery and maintain vehicle stability. In summary, step 204 involves sending an instruction to the regenerative braking unit to apply the regenerative braking parameter during a specified portion of the regenerative braking period. This step ensures that the regenerative braking system operates effectively, balancing the need for energy recovery with the requirement for vehicle stability and safety. The need to gain more energy during regenerative braking, as the energy gained during regenerative braking may be much lower than the energy gained under the actual grip of the vehicle. There is a growing need to improve the efficiency of regenerative braking systems to maximize energy recovery while maintaining safety.

### Hazard Detection in Relation to an Electric Vehicle Braking System

Regenerative braking is a key feature in electric vehicles, where the kinetic energy of the vehicle is converted back into electrical energy to recharge the battery during braking. However, when the battery is fully charged, the regenerative braking system cannot store more energy, which can lead to excessive reliance on traditional friction brakes, potentially causing overheating and failure.

In accordance with embodiments, a brake hazard prevention method is provided for an electrical vehicle. The method includes obtaining electrical vehicle battery unit fullness information indicative of the fullness of an electrical vehicle battery unit and obtaining brake temperature information related to the temperature of brakes of the electrical vehicle that are associated with regenerative braking wheels. The method further involves determining a probability of a failure of the brakes, which is responsive to the path of the electrical vehicle and also to the existence of steep and continuous braking sessions within a future path of the electrical vehicle.

There is provided a method that involves obtaining information indicative of the fullness of an electrical vehicle battery unit and brake temperature information related to the temperature of brakes associated with regenerative braking wheels. The method includes determining a probability of brake failure and generating a hazard alert when the probability exceeds a defined threshold. The alert may be associated with a request to enter a brake cooling period where the vehicle is stationary. Additionally, the determination of the probability can be responsive to the vehicle's path, including the existence of steep and continuous braking sessions within a future path.

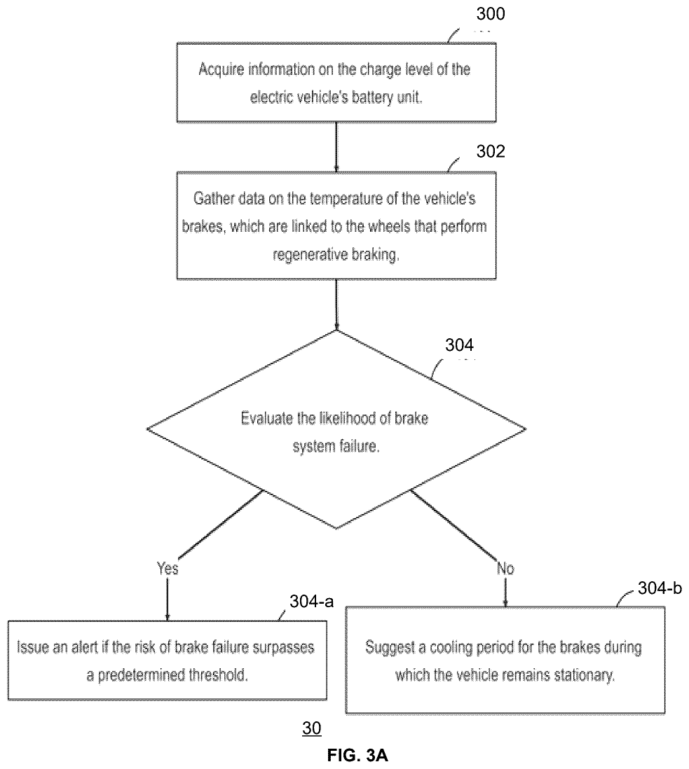

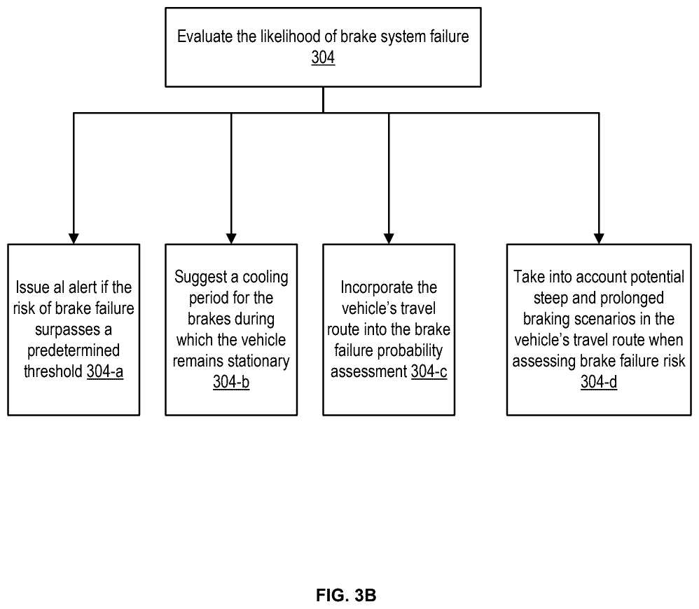

FIG. 3 illustrates method 30 that starts by step 300 that includes obtaining electrical vehicle battery unit fullness information indicative of a fullness of an electrical vehicle battery unit. Regenerative braking is based on converting kinetic energy to electrical energy, which is then used to charge the battery of the electric vehicle. When the battery is full, regenerative braking virtually turns into regular braking. This transition is significant because the brakes heat and may fail, especially when the brakes are designed based on the assumption that regenerative braking is possible. The fullness information indicative of a fullness of the electrical vehicle battery unit is used to determine a probability of a failure of the brakes. This describes a limitation of regenerative braking, where it becomes ineffective once the vehicle's battery is fully charged, leading to potential overheating and failure of the brakes if they are not designed to handle regular braking scenarios. The actions involved in this step include converting kinetic energy to electrical energy, used to charge the battery, and storing energy. These actions are for the functioning of regenerative braking, which enhances the efficiency of the vehicle's energy use. However, when the battery is full, regenerative braking virtually turns into regular braking, and the brakes heat and may fail. This is particularly problematic when the brakes are designed with the assumption that regenerative braking is always possible. The specific attributes of the electrical vehicle battery unit include fullness information indicative of a fullness, which is used to determine a probability of a failure of the brakes. This highlights the risk associated with brakes that are designed with the assumption of continuous regenerative braking capability, which may not be able to handle the heat generated during regular braking, leading to potential brake failure. The purpose of regenerative braking in this context is to convert kinetic energy into electrical energy, which is then used to charge the battery of the electric vehicle, thereby enhancing the efficiency of the vehicle's energy use. In summary, step 300 involves obtaining information about the fullness of the electrical vehicle battery unit, which directly impacts the effectiveness of regenerative braking. This information is used to assess the risk of brake failure, especially when the battery is full, and regenerative braking becomes ineffective, leading to potential overheating and failure of the brakes.

In step 302, the process involves obtaining brake temperature information related to the temperature of brakes of the electrical vehicle that are associated with regenerative braking wheels of the electrical vehicle. This step is for understanding the thermal state of the brakes, which is directly linked to their performance and safety. The brakes and the regenerative braking wheels are involved in this step. The action associated with these in the claims is obtaining brake temperature information, which is to relate to the temperature of brakes associated with regenerative braking.

The regenerative braking system converts kinetic energy into electrical energy, which is used to charge the battery of the electric vehicle. However, when the battery is full, regenerative braking virtually turns into regular braking, causing the brakes to heat and potentially fail. This is especially critical when the brakes are designed based on the assumption that regenerative braking is possible. The specific attributes of the brakes in the claims include temperature information related to the temperature of brakes. This is used to determine the probability of a failure of the brakes. The brakes heat and may fail, especially when the brakes are designed based on the assumption that regenerative braking is possible. This highlights the risk associated with brakes that are designed with the assumption of continuous regenerative braking capability, which may not be able to handle the heat generated during regular braking, leading to potential brake failure.

The regenerative braking wheels are associated with regenerative braking, which has the purpose of converting kinetic energy into electrical energy to charge the battery of the electric vehicle. This describes a limitation of regenerative braking, where it becomes ineffective once the vehicle's battery is fully charged, leading to potential overheating and failure of the brakes if they are not designed to handle regular braking scenarios. In summary, step 302 involves obtaining temperature information of the brakes to assess their thermal state and potential risk of failure. This step is in the context of regenerative braking systems, where the transition to regular braking due to a full battery can lead to overheating and brake failure, especially if the brakes are not designed to handle such scenarios.

In step 304, the process involves determining a probability of a failure of the brakes. This step is in assessing the risk of brake failure, especially in the context of regenerative braking systems in electric vehicles. The brakes are involved here. The action associated with the brakes in the claims is determining a probability of a failure of the brakes to assess the risk of brake failure. The brakes heat and may fail as a result of full battery or continuous use. This is particularly important because when the battery is full, regenerative braking virtually turns into regular braking, and the brakes heat and may fail, especially when the brakes are designed based on the assumption that regenerative braking is possible.

The specific attributes related to the brakes include temperature information related to a temperature of brakes. This is used to determine a probability of a failure of the brakes. The purpose of this is to highlight the risk associated with brakes that are designed with the assumption of continuous regenerative braking capability, which may not be able to handle the heat generated during regular braking, leading to potential brake failure. When the battery is full, regenerative braking virtually turns into regular braking and the brakes heat and may fail, especially when the brakes are designed based on the assumption that regenerative braking is possible. Sub-step 304-a involves generating a brake hazard alert when the probability exceeds a defined threshold.

The brake hazard alert is intended to warn about the potential failure of the brakes. This is because the brakes heat and may fail, especially when the brakes are designed based on the assumption that regenerative braking is possible. Sub-step 304-b is associated with a request to enter a brake cooling period in which the electrical vehicle is stationary. The brake cooling period is intended to reduce the temperature of the brakes and prevent failure. This is because the brakes heat and may fail, especially when the brakes are designed based on the assumption that regenerative braking is possible.

Sub-step 304-c states that the determining of the probability is also responsive to a path of the electrical vehicle. This describes a limitation of regenerative braking, where it becomes ineffective once the vehicle's battery is fully charged, leading to potential overheating and failure of the brakes if they are not designed to handle regular braking scenarios. When the battery is full, regenerative braking virtually turns into regular braking and the brakes heat and may fail, especially when the brakes are designed based on the assumption that regenerative braking is possible.

Sub-step 304-d mentions that the determining of the probability is also responsive to an existence of steep and continuous braking sessions within a future path of the electrical vehicle. This also describes a limitation of regenerative braking, where it becomes ineffective once the vehicle's battery is fully charged, leading to potential overheating and failure of the brakes if they are not designed to handle regular braking scenarios. When the battery is full, regenerative braking virtually turns into regular braking and the brakes heat and may fail, especially when the brakes are designed based on the assumption that regenerative braking is possible.

Overall, step 304 and its sub-steps are designed to ensure that the probability of brake failure is accurately assessed and mitigated, taking into account various factors such as brake temperature, vehicle path, and braking sessions. This comprehensive approach helps in preventing brake failure and ensuring the safety of the electric vehicle.

In sub-step 304-a, the process involves generating a brake hazard alert when the probability of brake failure exceeds a defined threshold. This step is for ensuring the safety of the electric vehicle by providing timely warnings to the driver or the vehicle's control system. The brake hazard alert is central to this sub-step. The action associated with this in the claims is to warn when the probability of brake failure exceeds a defined threshold. This alert serves as a warning mechanism to prevent potential brake failure, which could lead to hazardous situations.

Regenerative braking of an electric vehicle is based on converting kinetic energy to electrical energy, which is used to charge the battery of the electric vehicle. However, when the battery is full, regenerative braking virtually turns into regular braking, causing the brakes to heat and potentially fail, especially when the brakes are designed based on the assumption that regenerative braking is possible. This inherent limitation of regenerative braking underscores the importance of the brake hazard alert. The specific attributes of the brake hazard alert in the claims highlight its purpose to warn about the potential failure of the brakes. This is because the brakes may not be able to handle the heat generated during regular braking, leading to potential brake failure. When the battery is full, regenerative braking virtually turns into regular braking, and the brakes heat and may fail, especially when the brakes are designed based on the assumption that regenerative braking is possible.

In summary, sub-step 304-a involves generating a brake hazard alert to warn when the probability of brake failure exceeds a defined threshold. This alert is for mitigating the risks associated with the limitations of regenerative braking, particularly when the vehicle's battery is fully charged, and the brakes are subjected to regular braking conditions. The alert helps in preventing potential brake failure by providing timely warnings, thereby enhancing the safety of the electric vehicle.

In sub-step 304-b, the process involves a request to enter a brake cooling period in which the electrical vehicle is stationary. This sub-step is for preventing brake failure due to overheating, especially in scenarios where regenerative braking becomes ineffective. The brake cooling period is initiated to reduce the temperature of the brakes and prevent failure. This is because when the battery of an electric vehicle is full, regenerative braking virtually turns into regular braking. This transition can cause the brakes to heat up and potentially fail, especially if the brakes are designed based on the assumption that regenerative braking is always possible. The purpose of this is to highlight the risk associated with brakes that are designed with the assumption of continuous regenerative braking capability, which may not be able to handle the heat generated during regular braking, leading to potential brake failure. The brake cooling period ensures that the vehicle remains stationary, allowing the brakes to cool down and thus preventing any potential failure due to overheating. This step is for maintaining the safety and functionality of the braking system in electric vehicles, particularly in situations where the regenerative braking system is not effective due to a fully charged battery.

In step 304-c, the determining of the probability of a failure of the brakes is also responsive to a path of the electrical vehicle. This step involves considering the vehicle's path in the assessment of brake failure risk. The path of the electrical vehicle is involved here. The action associated with the path of the electrical vehicle in the claims is to consider the vehicle's path in the assessment of brake failure risk. This is because the path can significantly influence the braking requirements and, consequently, the probability of brake failure.

Regenerative braking of an electric vehicle is based on converting kinetic energy to electrical energy used to charge the battery of the electric vehicle. When the battery is full, regenerative braking virtually turns into regular braking, and the brakes heat and may fail, especially when the brakes are designed based on the assumption that regenerative braking is possible. This limitation of regenerative braking becomes particularly relevant when considering the vehicle's path, as certain paths may require more frequent or intense braking. The specific attributes related to the path of the electrical vehicle include the consideration of the vehicle's path in the assessment of brake failure risk. This describes a limitation of regenerative braking, where it becomes ineffective once the vehicle's battery is fully charged, leading to potential overheating and failure of the brakes if they are not designed to handle regular braking scenarios. When the battery is full, regenerative braking virtually turns into regular braking, and the brakes heat and may fail, especially when the brakes are designed based on the assumption that regenerative braking is possible. In summary, step 304-c emphasizes the importance of considering the path of the electrical vehicle in determining the probability of brake failure. This consideration is due to the limitations of regenerative braking, which can lead to brake overheating and failure when the battery is full, particularly on paths that require frequent or intense braking.

In step 304-d, the process involves determining the probability of brake failure by considering the existence of steep and continuous braking sessions within a future path of the electrical vehicle. This step is for assessing the risk of brake failure, especially in scenarios where the vehicle's path includes challenging driving conditions that require frequent and intense braking. The steep and continuous braking sessions and future path of the electrical vehicle are identified for this step.

These are correlated with the actions and attributes described in the claims. The action associated with steep and continuous braking sessions in the claims is to consider the potential for steep and continuous braking in the future path for assessing brake failure risk. This is because continuous braking can lead to significant heat generation in the brakes, increasing the likelihood of brake failure. Regenerative braking is designed to convert kinetic energy into electrical energy to charge the battery. However, when the battery is full, regenerative braking becomes ineffective, and the vehicle relies on regular braking, which can cause the brakes to overheat and potentially fail, especially if they are not designed to handle such conditions. The action associated with future path of the electrical vehicle in the claims is to consider the vehicle's path in the assessment of brake failure risk.

This involves analyzing the route the vehicle will take and identifying any segments that may require frequent or intense braking. The limitation of regenerative braking is highlighted, where it becomes ineffective once the vehicle's battery is fully charged. This leads to potential overheating and failure of the brakes if they are not designed to handle regular braking scenarios. The specific attributes related to these include the consideration of steep and continuous braking sessions and the future path of the electrical vehicle. These are for determining the probability of brake failure. When the battery is full, regenerative braking virtually turns into regular braking, causing the brakes to heat and potentially fail.

This is particularly problematic when the brakes are designed based on the assumption that regenerative braking is possible. In summary, step 304-d involves a detailed analysis of the vehicle's future path and the potential for steep and continuous braking sessions to assess the risk of brake failure. This step is for ensuring the safety and reliability of the braking system, especially in electric vehicles where regenerative braking may not always be effective. The attributes and actions associated with this step highlight the importance of considering the limitations of regenerative braking and the need for robust brake design to handle regular braking scenarios

There is provided a brake hazard prevention method, that includes obtaining electrical vehicle battery unit fullness information indicative of a fullness of an electrical vehicle battery unit; obtaining brake temperature information related to a temperature of brakes of the electrical vehicle that are associated with regenerative braking wheels of the electrical vehicle; and determining a probability of a failure of the brakes.

According to an embodiment, the method includes generating a brake hazard alert when the probability exceeds a defined threshold.

According to an embodiment, the brake hazard alert is associated with a request to enter a brake cooling period in which the electrical period is stationary.

According to an embodiment, the determining of the probability is also responsive to a path of the electrical vehicle.

According to an embodiment, the determining of the probability is also responsive to an existence of steep and continuous braking sessions within a future path of the electrical vehicle.

There is provided a non-transitory computer readable medium for brake hazard prevention, the non-transitory computer readable medium stores instructions executable by a processor for obtaining electrical vehicle battery unit fullness information indicative of a fullness of an electrical vehicle battery unit; obtaining brake temperature information related to a temperature of brakes of the electrical vehicle that are associated with regenerative braking wheels of the electrical vehicle; and determining a probability of a failure of the brakes.

According to an embodiment, the non-transitory computer readable medium stores instructions executable by a processor for generating a brake hazard alert when the probability exceeds a defined threshold.

According to an embodiment, the brake hazard alert is associated with a request to enter a brake cooling period in which the electrical period is stationary.

According to an embodiment, the determining of the probability is also responsive to a path of the electrical vehicle.

According to an embodiment, the determining of the probability is also responsive to an existence of steep and continuous braking sessions within a future path of the electrical vehicle.

There is provided a computerized system for brake hazard prevention, computerized system that comprises a processor configured to obtain electrical vehicle battery unit fullness information indicative of a fullness of an electrical vehicle battery unit; obtain brake temperature information related to a temperature of brakes of the electrical vehicle that are associated with regenerative braking wheels of the electrical vehicle; and determine a probability of a failure of the brakes.

### Electric Vehicle Sensing System Error Mitigation

Phantom braking in electric vehicles is a phenomenon where the vehicle's automated systems incorrectly detect an obstacle and initiate an unnecessary braking maneuver, which can be sudden and unexpected. This can lead to discomfort for passengers and potentially hazardous situations on the road. The issue arises from the limitations and errors in the sensing and perception algorithms used by the vehicle's advanced driver-assistance systems (ADAS). As electric vehicles become more prevalent and increasingly rely on automated systems for safety and convenience, the need to address phantom braking becomes more critical to ensure the reliability and trustworthiness of these systems.

A method for reducing the impact of phantom braking includes obtaining an estimate that an object is in the future path of a vehicle and performing an initial regenerative braking session with a specific initial value for the regenerative braking parameter. During this session, grip information indicative of the vehicle's grip is obtained. Based on this estimate and grip information, a decision is made whether to postpone the continuation of regenerative braking until the estimate is validated. The regenerative braking unit is instructed to continue regenerative braking after a decision not to postpone or after a postponement followed by validation of the estimate. Conversely, the continuation of regenerative braking is avoided if the estimate is invalidated.

In accordance with embodiments, a method is provided for reducing the impact of phantom braking in an electric vehicle. The method includes obtaining an estimate that an object is located at a future path of the vehicle and performing an initial regenerative braking session with a regenerative braking parameter set to an initial value. During this session, grip information indicative of the vehicle's grip is obtained. Based on the estimate and grip information, a decision is made whether to postpone the continuation of regenerative braking until the estimate is validated. The regenerative braking unit is instructed to continue regenerative braking if the continuation is not postponed or if it is preceded by a validated estimate. Conversely, the continuation of regenerative braking is avoided if the estimate is invalidated. Additionally, the method may involve determining a value for the regenerative braking parameter based on the grip information and applying this parameter during the continuation of regenerative braking. The grip information can be generated based on radial speeds of both regenerative and non-regenerative braking wheels of the electric vehicle. The initial regenerative braking session is characterized by being shorter than one second and resulting in a vehicle deceleration of less than 0.2 g—or any duration and/or regenerative braking strength that will not significantly (by no more than 5, 10, 20, 30, 40 percent) impact the comfort of the driving. For example—will not cause the head of a passenger or driver to move forward by more than 1, 2, 3, 4, 5, 6, centimeters and the like, will not cause the seatbelt to lock, will not cause a passenger to vomit, and the like.

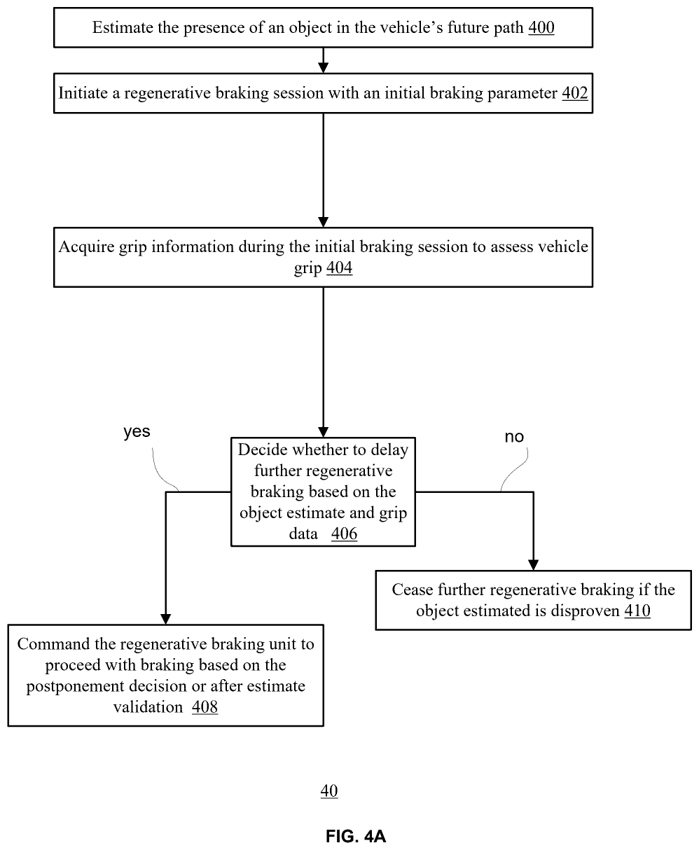

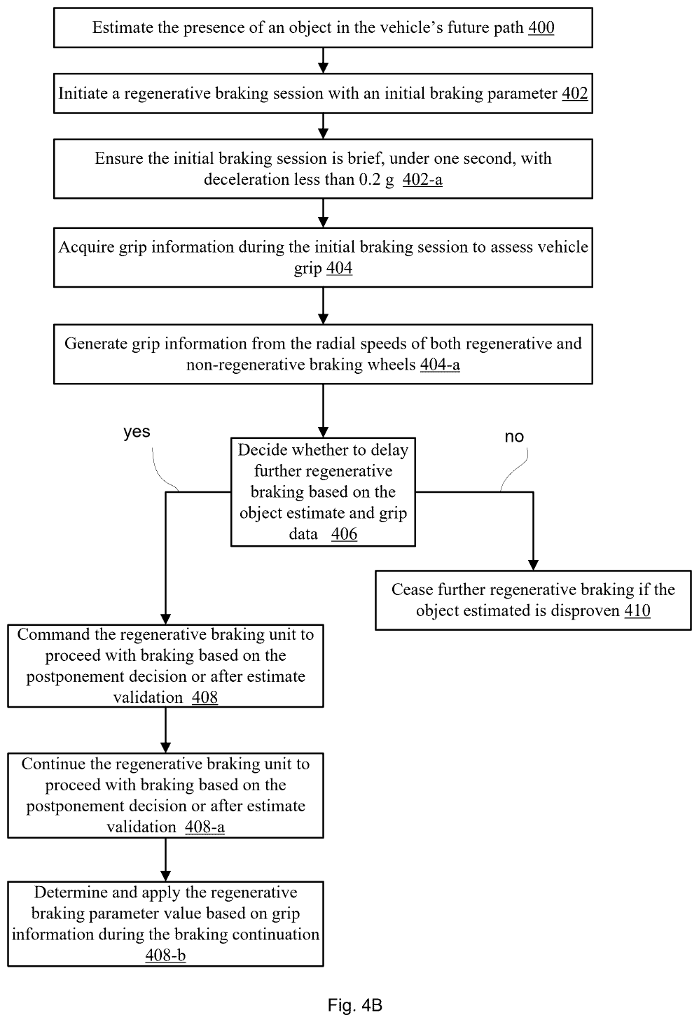

FIG. 4 illustrates method 40 that starts by step 400 of obtaining an estimate that an object is located at a future path of the vehicle. This step is for reducing the impact of phantom braking, which is a sudden regenerative braking due to non-existing objects erroneously detected by electric vehicle sensing systems. The method aims to improve safety and efficiency by anticipating potential obstacles. The components involved in this step include non-existing objects and electric vehicle sensing systems.

The electric vehicle sensing systems are responsible for detecting objects on the vehicle's future path. However, these systems can sometimes erroneously detect non-existing objects, leading to phantom braking. The goal is to identify the error in the vehicle's sensing systems that leads to phantom braking, which is the false detection of objects that are not actually present. This explains the cause of phantom braking, which is the incorrect detection of non-existent objects by the vehicle's sensing systems, leading to an unnecessary engagement of regenerative braking.

The actions associated with this step include obtaining an estimate, which is done to anticipate potential obstacles. The electric vehicle sensing systems are described as erroneously detecting non-existing objects, indicating the error in detection that leads to phantom braking. The goal is to stop phantom braking by preventing the false detection of objects.

In summary, step 400 involves obtaining an estimate that an object is located at a future path of the vehicle to reduce the impact of phantom braking. This step addresses the need to prevent phantom braking caused by the erroneous detection of non-existing objects by electric vehicle sensing systems. The method aims to improve safety and efficiency by accurately anticipating potential obstacles and preventing unnecessary regenerative braking.

In step 402, the method involves performing an initial regenerative braking session while applying a regenerative braking parameter of an initial value. This step is for initiating the deceleration process in the context of reducing the impact of phantom braking. The regenerative braking parameter of an initial value is applied to perform this initial session. The regenerative braking parameter defines the initial conditions under which the regenerative braking is initiated.

The regenerative braking process is to prevent phantom braking, which is sudden regenerative braking due to non-existing objects erroneously detected by electric vehicle sensing systems. The purpose of this step is to initiate deceleration in a controlled manner to assess the road conditions and the vehicle's response. Sub-step 402-a further elaborates that the preliminary regenerative braking session is shorter than one second and results in decelerating the vehicle by less than 0.2 g. This defines the duration and deceleration limit of the preliminary regenerative braking session, ensuring that the initial braking is gentle and does not cause significant deceleration, which could be uncomfortable or unsafe for the vehicle occupants.

The regenerative braking parameter of an initial value is applied during this short session to gather initial data on the vehicle's grip and braking performance. This data is for subsequent steps where the grip information is obtained and used to determine whether to continue or postpone the regenerative braking based on the validation of the estimate that an object is located at the future path of the vehicle. In summary, step 402 involves initiating a controlled and gentle regenerative braking session to gather initial data on the vehicle's braking performance, which is for preventing phantom braking and ensuring the safety and efficiency of the vehicle's braking system.

In step 402-a, the preliminary regenerative braking session is shorter than one second and results in decelerating the vehicle by less than 0.2 g. This step involves the preliminary regenerative braking session and the regenerative braking. The preliminary regenerative braking session is a phase where the vehicle initiates a brief deceleration to gather data. This session is designed to be very short, lasting less than one second, and it results in a deceleration of the vehicle by less than 0.2 g. The purpose of this session is to perform an initial assessment without significantly impacting the vehicle's speed or stability.

During this session, the regenerative braking system is activated to apply a regenerative braking parameter of an initial value. This initial value sets the baseline for the braking force applied during this preliminary phase. The regenerative braking system, which is responsible for converting the vehicle's kinetic energy back into stored energy, plays a role in this process.

The grip information obtained during this preliminary session is indicative of the grip associated with the electrical vehicle. This information is for assessing the road conditions and the vehicle's interaction with the surface. The grip information is generated based on the radial speeds of the regenerative braking wheels and the non-regenerative braking wheels of the electric vehicle. By comparing these radial speeds, the system can evaluate the performance of the wheels and determine the grip level. The regenerative braking system's ability to perform this initial session efficiently is for the subsequent steps in the method. It ensures that the vehicle can gather accurate data without causing unnecessary deceleration or instability. This data is then used to make informed decisions about whether to continue or postpone the regenerative braking process based on the validation of the estimate that an object is located at the future path of the vehicle.

In summary, step 402-a involves a brief preliminary regenerative braking session that lasts less than one second and results in a deceleration of less than 0.2 g. This session is for gathering grip information based on the radial speeds of the vehicle's wheels, which is for the subsequent decision-making process in the method for reducing the impact of phantom braking.

In step 404, the method involves obtaining grip information during the preliminary regenerative braking session. This grip information is indicative of a grip associated with the electrical vehicle. The grip information is generated based on radial speeds of regenerative braking wheels of an electric vehicle and on radial speeds of non-regenerative braking wheels of the electric vehicle. This step is for assessing road conditions and determining whether to continue or postpone the regenerative braking process. The grip information is for evaluating the performance of the wheels and the overall grip of the vehicle on the road. By comparing the radial speeds of the regenerative braking wheels and the non-regenerative braking wheels, the system can generate accurate grip information. This information helps in making informed decisions about the continuation of the regenerative braking process.

The preliminary regenerative braking session, which is shorter than one second and results in decelerating the vehicle by less than 0.2 g, is designed to gather initial grip information without significantly affecting the vehicle's speed. This brief session ensures that the vehicle's grip is assessed quickly and efficiently, allowing for timely decisions regarding the braking process.

In summary, step 404 involves obtaining grip information during a brief preliminary regenerative braking session. This information is generated by comparing the radial speeds of the regenerative braking wheels and the non-regenerative braking wheels, providing data for assessing road conditions and making decisions about the continuation of the regenerative braking process.

In sub-step 404-a, the grip information is generated based on radial speeds of regenerative braking wheels of an electric vehicle and on radial speeds of non-regenerative braking wheels of the electric vehicle. This step involves comparing the radial speeds of both regenerative braking wheels and non-regenerative braking wheels to evaluate wheel performance. The purpose of generating grip information is to monitor road conditions, which is for determining the value of a regenerative braking parameter.

The grip information is indicative of a grip associated with the electrical vehicle, which assists in determining whether to postpone the continuation of regenerative braking. This grip information is for assessing road conditions and making informed decisions about the braking process. The attributes of the grip information include its generation based on the radial speeds of both types of wheels, which provides an understanding of the vehicle's interaction with the road surface. The regenerative braking wheels and non-regenerative braking wheels play a role in this process.

By comparing their radial speeds, the system can evaluate the performance of the wheels and generate grip information. This information is then used to optimize the braking efficiency and ensure the safety and stability of the vehicle during regenerative braking. Phantom braking includes sudden regenerative braking due to non-existing objects erroneously detected by electric vehicle sensing systems. There is a need to prevent phantom braking, and generating grip information based on the radial speeds of the wheels is a step in achieving this goal.

By assessing the grip associated with the electrical vehicle, the system can make informed decisions about whether to continue or postpone regenerative braking, thereby reducing the impact of phantom braking and improving the overall safety and efficiency of the vehicle.

In step 406, the method involves determining, based on the estimate and the grip information, whether to postpone a continuation of the regenerative braking until validating the estimate. This step is in the context of reducing the impact of phantom braking, which is sudden regenerative braking due to non-existing objects erroneously detected by electric vehicle sensing systems.

The method aims to improve safety and efficiency by preventing unnecessary deceleration caused by phantom braking. The components involved in this step include the method, the estimate, and the grip information. The method is designed to reduce the impact of phantom braking by determining the presence of an object on the vehicle's future path. The estimate is an assessment that an object is located at a future path of the vehicle, which helps in anticipating potential obstacles. The grip information is indicative of a grip associated with the electrical vehicle and is used to assess road conditions. The attributes of the components include an estimate that an object is located at a future path of the vehicle, which is to reduce the impact of phantom braking by determining the presence of an object on the vehicle's future path. The grip information is indicative of a grip associated with the electrical vehicle, which assists in determining whether to postpone the continuation of regenerative braking.

Phantom braking includes sudden regenerative braking due to non-existing objects erroneously detected by electric vehicle sensing systems. There is a need to prevent phantom braking, which is the false detection of objects that are not actually present. This explains the cause of phantom braking, which is the incorrect detection of non-existent objects by the vehicle's sensing systems, leading to an unnecessary engagement of regenerative braking.

The method involves obtaining an estimate to anticipate potential obstacles and obtaining grip information to assess road conditions. Based on these inputs, the method determines whether to postpone the continuation of regenerative braking. This decision-making process is based on road conditions and the object estimate, ensuring that regenerative braking is only continued if it is necessary and safe to do so. This step is in preventing unnecessary deceleration and improving the overall safety and efficiency of the vehicle's braking system.

In step 408, the method involves instructing a regenerative braking unit to continue the regenerative braking following a determination not to postpone the continuation of the regenerative braking or following a postponement of the continuation that is preceded by validating the estimate. This step is in the context of reducing the impact of phantom braking, which is a sudden regenerative braking due to non-existing objects erroneously detected by electric vehicle sensing systems. The components involved in this step include the method and regenerative braking. The method is designed to improve safety and efficiency by reducing the impact of phantom braking. The regenerative braking unit is instructed to control the braking process, ensuring that the vehicle does not decelerate unnecessarily due to false detections.

Sub-step 408-a involves continuing the regenerative braking following the determination not to postpone the continuation of the regenerative braking or following the postponement of the continuation that is preceded by validating the estimate. This ensures that the braking process is maintained only when necessary, optimizing the vehicle's performance and safety.

Sub-step 408-b involves determining, based on the grip information, a value of a regenerative braking parameter, and applying this parameter during a portion of the continuation of the regenerative braking. This step is for optimizing the braking efficiency by using the grip information to assess road conditions and adjust the braking parameters accordingly. The grip information is indicative of a grip associated with the electrical vehicle and is generated based on the radial speeds of regenerative braking wheels and non-regenerative braking wheels of the electric vehicle. This information helps in determining whether to postpone the continuation of the regenerative braking until validating the estimate, ensuring that the vehicle's braking system responds accurately to real road conditions.

The preliminary regenerative braking session is shorter than one second and results in decelerating the vehicle by less than 0.2 g. This defines the duration and deceleration limit of the preliminary regenerative braking session, ensuring that the initial braking does not cause significant deceleration, which could lead to discomfort or safety issues. Overall, step 408 and its sub-steps ensure that the regenerative braking system operates efficiently and safely, reducing the impact of phantom braking by accurately responding to real road conditions and avoiding unnecessary deceleration due to false detections.

In step 408-a, the method involves continuing the regenerative braking following the determination not to postpone the continuation of the regenerative braking or following the postponement of the continuation that is preceded by validating the estimate. This step is in the context of reducing the impact of phantom braking, which is a sudden regenerative braking due to non-existing objects erroneously detected by electric vehicle sensing systems. The method aims to improve safety and efficiency by reducing the impact of phantom braking. The regenerative braking process is initiated to decelerate the vehicle, and the continuation of this braking is controlled based on the validation of the estimate that an object is located at a future path of the vehicle. The regenerative braking unit is instructed to continue the braking process if it is determined that there is no need to postpone it or if the postponement is followed by a validation of the estimate. The regenerative braking parameter is applied during the continuation of the regenerative braking to maintain the deceleration process. This parameter is optimized to ensure efficient braking.

The grip information, which is indicative of the grip associated with the electrical vehicle, is obtained during the preliminary regenerative braking session. This information is used to assess road conditions and assist in determining whether to postpone the continuation of the regenerative braking. The grip information is generated based on the radial speeds of regenerative braking wheels and non-regenerative braking wheels of the electric vehicle. This comparison of radial speeds helps evaluate wheel performance and monitor road conditions.

The preliminary regenerative braking session is shorter than one second and results in decelerating the vehicle by less than 0.2 g, defining the duration and deceleration limit of this session. In summary, step 408-a involves a methodical approach to continue regenerative braking based on validated estimates and grip information, ensuring that the braking process is efficient and prevents unnecessary deceleration due to phantom braking. This method addresses the need to prevent phantom braking by accurately detecting non-existing objects and controlling the regenerative braking process accordingly.

In sub-step 408-b, the method involves determining, based on the grip information, a value of a regenerative braking parameter and applying, during a portion of the continuation of the regenerative braking, the regenerative braking parameter. The primary component involved in this sub-step is the regenerative braking system. The method aims to optimize braking efficiency by determining the value of a regenerative braking parameter. This determination is based on grip information, which is indicative of the grip associated with the electrical vehicle.

The grip information helps in assessing road conditions and making informed decisions about the braking process. The grip information is generated based on radial speeds of regenerative braking wheels of an electric vehicle and on radial speeds of non-regenerative braking wheels of the electric vehicle. This comparison of radial speeds helps in evaluating wheel performance and, consequently, the grip of the vehicle on the road. Once the value of the regenerative braking parameter is determined, it is applied during a portion of the continuation of the regenerative braking. This application of the regenerative braking parameter is for executing optimized braking, ensuring that the vehicle decelerates efficiently and safely. The regenerative braking parameter of an initial value is used to perform an initial regenerative braking session, which is shorter than one second and results in decelerating the vehicle by less than 0.2 g. This preliminary session helps in obtaining grip information, which is then used to determine whether to continue or postpone the regenerative braking. The method described in sub-step 408-b is part of a broader strategy to reduce the impact of phantom braking, which includes sudden regenerative braking due to non-existing objects erroneously detected by electric vehicle sensing systems. By determining and applying the regenerative braking parameter based on real-time grip information, the method aims to prevent unnecessary deceleration and improve the overall safety and efficiency of the vehicle's braking system.

In step 410, the method involves avoiding the continuation of the regenerative braking following an invalidation of the estimate. This step is in the context of preventing phantom braking, which is described as sudden regenerative braking due to non-existing objects erroneously detected by electric vehicle sensing systems. The method aims to reduce the impact of phantom braking by determining the presence of an object on the vehicle's future path and making decisions based on this estimate and grip information. The method is associated with avoiding the continuation of regenerative braking to prevent unnecessary deceleration. This action is to improve safety and efficiency by ensuring that the vehicle does not decelerate unnecessarily due to false detections.

The attribute related to this action is the estimate that an object is located at a future path of the vehicle, which helps in reducing the impact of phantom braking by determining the presence of an object on the vehicle's future path. Phantom braking is described as included sudden regenerative braking due to non-existing objects erroneously detected by electric vehicle sensing systems. This erroneous detection leads to unnecessary engagement of regenerative braking. The goal is to identify the error in the vehicle's sensing systems that leads to phantom braking, which is the false detection of objects that are not actually present. This explains the cause of phantom braking, which is the incorrect detection of non-existent objects by the vehicle's sensing systems, leading to an unnecessary engagement of regenerative braking.

Regenerative braking is involved in avoiding the continuation of regenerative braking. This action is included to prevent sudden and unnecessary deceleration due to phantom braking. The regenerative braking process is controlled by a regenerative braking unit, which continues or avoids the continuation of regenerative braking based on the validation of the estimate. The grip information, which is indicative of a grip associated with the electrical vehicle, assists in determining whether to postpone the continuation of regenerative braking.

In summary, step 410 involves a method to avoid the continuation of regenerative braking following an invalidation of the estimate to prevent unnecessary deceleration due to phantom braking. This method improves safety and efficiency by ensuring that the vehicle does not decelerate unnecessarily due to false detections of non-existing objects by the vehicle's sensing systems. The regenerative braking process is controlled by a regenerative braking unit, and the decision to continue or avoid regenerative braking is based on the validation of the estimate and grip information.

There is provided a method for reducing an impact of phantom braking, the method includes obtaining an estimate that an object is located at a future path of the vehicle; performing an initial regenerative braking session while applying a regenerative braking parameter of an initial value; obtaining grip information, during the preliminary regenerative braking session, the grip information is indicative of a grip associated with the electrical vehicle; determining, based on the estimate and the grip information, whether to postpone a continuation of the regenerative braking until validating the estimate; instructing a regenerative braking unit to continue the regenerative braking following a determination not to postpone the continuation of the regenerative braking or following a postponement of the continuation that is preceded by validating the estimate; and avoiding the continuation of the regenerative braking following an invalidation of the estimate.

According to an embodiment, the method includes continuing the regenerative braking following the determination not to postpone the continuation of the regenerative braking or following the postponement of the continuation that is preceded by validating the estimate.

According to an embodiment, the method includes determining, based on the grip information, a value of a regenerative braking parameter; and applying, during a portion of the continuation of the regenerative braking, the regenerative braking parameter.

According to an embodiment, the grip information is generated based on radial speeds of regenerative braking wheels of an electric vehicle and on radial speeds of non-regenerative braking wheels of the electric vehicle.

According to an embodiment, during the preliminary regenerative braking session is shorter than one second and results in decelerating the vehicle by less than 0.2 g.

There is provided a non-transitory computer readable medium for reducing an impact of phantom braking, the non-transitory computer readable medium stores instructions executable by a processor for obtaining an estimate that an object is located at a future path of the vehicle; performing an initial regenerative braking session while applying a regenerative braking parameter of an initial value; obtaining grip information, during the preliminary regenerative braking session, the grip information is indicative of a grip associated with the electrical vehicle; determining, based on the estimate and the grip information, whether to postpone a continuation of the regenerative braking until validating the estimate; instructing a regenerative braking unit to continue the regenerative braking following a determination not to postpone the continuation of the regenerative braking or following a postponement of the continuation that is preceded by validating the estimate; and avoiding the continuation of the regenerative braking following an invalidation of the estimate.

According to an embodiment, the non-transitory computer readable medium stores instructions executable by a processor for continuing the regenerative braking following the determination not to postpone the continuation of the regenerative braking or following the postponement of the continuation that is preceded by validating the estimate.

According to an embodiment, the non-transitory computer readable medium stores instructions executable by a processor for determining, based on the grip information, a value of a regenerative braking parameter; and applying, during a portion of the continuation of the regenerative braking, the regenerative braking parameter.

According to an embodiment, the grip information is generated based on radial speeds of regenerative braking wheels of an electric vehicle and on radial speeds of non-regenerative braking wheels of the electric vehicle.

According to an embodiment, during the preliminary regenerative braking session is shorter than one second and results in decelerating the vehicle by less than 0.2 g.

There is provided a computerized system for reducing an impact of phantom braking, the computerized system includes a processor configured to obtain an estimate that an object is located at a future path of the vehicle; perform an initial regenerative braking session while applying a regenerative braking parameter of an initial value; obtain grip information, during the preliminary regenerative braking session, the grip information is indicative of a grip associated with the electrical vehicle; determine, based on the estimate and the grip information, whether to postpone a continuation of the regenerative braking until validating the estimate; instruct a regenerative braking unit to continue the regenerative braking following a determination not to postpone the continuation of the regenerative braking or following a postponement of the continuation that is preceded by validating the estimate; and avoid the continuation of the regenerative braking following an invalidation of the estimate.

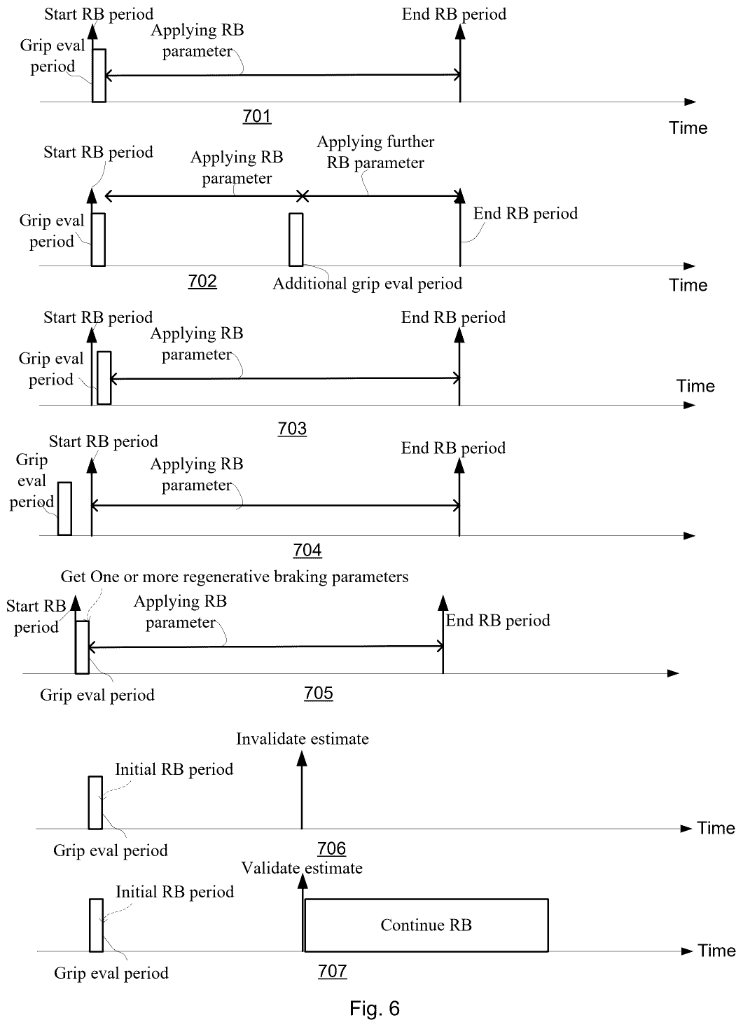

FIG. 6 illustrate examples of a vehicle 600 and that include communication system 630, one or more memory and/or storage units 620, processing system 624 including processor 626. The communication system 630, the one or more memory and/or storage units 620, and the processing system 624 may belong to a computerized system. The computerized system may be a server, a laptop, a desktop or any other computer and may include or be in communication with a sensing unit and/or a controller.

According to an embodiment, vehicle 600 is in communication with network 632 and one or more other remote computerized systems 634 that are in communication with network 632.

According to an embodiment, the communication system 630 is configured to enable communication between the one or more memory and/or storage units 620 and/or the sensing system 660 and/or any one of the additional units and/or the network 632 (that is in communication with the remote computerized systems).

The memory and/or storage units 620 was shown as storing software 693. Any reference to software should be applied mutatis mutandis to code and/or firmware and/or instructions and/or commands, and the like.

Processor 626 includes a plurality of processing units 626(6)-626(J), J is an integer that exceeds one. Any reference to one unit or item should be applied mutatis mutandis to multiple units or items. For example—any reference to processor should be applied mutatis mutandis to multiple processors, any reference to communication system 630 should be applied mutatis mutandis to multiple communication systems.

According to an embodiment, the one or more memory and/or storage units 620 includes one or more memory unit, each memory unit may include one or more memory banks.

According to an embodiment, the one or more memory and/or storage units 620 includes a volatile memory and/or a non-volatile memory. The one or more memory and/or storage units 620 may be a random-access memory (RAM) and/or a read only memory (ROM).

According to an embodiment, the non-volatile memory unit is a mass storage device, which can provide non-volatile storage of computer code, computer readable instructions, data structures, program modules, and other data for the processor or any other unit of vehicle. For example, and not meant to be limiting, a mass storage device can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any content may be stored in any part or any type of the memory and/or storage units.

According to an embodiment, the at least one memory unit stores at least one database—such as any database known in the art—such as DB2®, Microsoft® Access, Microsoft® SQL Server, Oracle®, mySQL, PostgreSQL, and the like.

The memory and/or storage units 620 are configured to store firmware and/or software, one or more operating systems, data and metadata required to the execution of any of the methods mentioned in this application.

The memory and/or storage units 620 was shown as storing software. Any reference to software should be applied mutatis mutandis to code and/or firmware and/or instructions and/or commands, and the like.

Various units and/or components are in communication with each other using any communication elements and/or protocols. An example of a communication system is denoted 630. Other communication elements may be provided.

The communication system 630 may be in communication with bus 636. The bus represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus, and all buses specified in this description can also be implemented over a wired or wireless network connection and each of the subsystems.

Network 632 that is located outside the vehicle and is used for communication between the vehicle and at least one remote computing system. By way of example, a remote computing system can be a personal computer, a laptop computer, portable computer, a server, a router, a network computer, a peer device or other common network node, and so on. Logical connections between the processor and either one of remote computing systems can be made via a local area network (LAN) and a general wide area network (WAN). Such network connections can be through a network adapter (may belong to communication system 630) which can be implemented in both wired and wireless environments. Such networking environments are conventional and commonplace in offices, enterprise-wide computer networks, intranets, and a larger network such as the internet.

It should be noted that at least a part of the content illustrated as being stored in one or more memory/storage units 620 may be stored outside the vehicle. It should also be noted that the processor may evaluate signatures generated by a plurality of detectors.

According to an embodiment, the memory and/or storage units 620 stores at least one of: operating system 694, information 696, metadata 692, and software 693.

Using the software, the processing system is configured to execute one or more method illustrated in this application.

Vehicle 600 also includes sensing system 660 and control unit 625.

The control unit 625 may cooperate with regenerative braking unit 622.

The control unit 625 may cooperate may be in communication with a vehicle computer is configured to control the operation of the vehicle-especially controlling the engine, the transmission, and any other vehicle system or component.

The vehicle computer may be in communication with an engine control module, a transmission control module, a powertrain control module, and the like.

The sensing system 660 may include optics, a sensing element group, a readout circuit, and an image signal processor. Optics are followed by a sensing element group such as line of sensing elements or an array of sensing elements that form the sensing element group. The sensing element group is followed by a readout circuit that reads detection signals generated by the sensing element group. An image signal processor is configured to perform an initial processing of the detection signals—for example by improving the quality of the detection information, performing noise reduction, and the like. The sensing system 660 is configured to output one or more sensed information units (SIUs).

The control unit 625 is configured to control the operation of the sensing system 660, and/or the one or more memory and/or storage units 620 and/or the one or more additional units and/or the regenerative braking unit 622.

The regenerative braking unit 622 is configured to perform a regenerative braking of regenerative braking wheels 670. The vehicle also includes non-regenerative braking wheels 672.

The vehicle may include 2, 3, or more than four wheels.

According to an embodiment, the one or more memory and/or storage units 620 includes one or more memory unit, each memory unit may include one or more memory banks.

According to an embodiment, the one or more memory and/or storage units 620 includes a volatile memory and/or a non-volatile memory. The one or more memory and/or storage units 620 may be a random-access memory (RAM) and/or a read only memory (ROM).

According to an embodiment, the non-volatile memory unit is a mass storage device, which can provide non-volatile storage of computer code, computer readable instructions, data structures, program modules, and other data for the processor or any other unit of vehicle. For example, and not meant to be limiting, a mass storage device can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by a computer.

Any content may be stored in any part or any type of the memory and/or storage units.

According to an embodiment, the at least one memory unit stores at least one database—such as any database known in the art—such as DB2®, Microsoft® Access, Microsoft® SQL Server, Oracle®, mySQL, PostgreSQL, and the like.

Various units and/or components are in communication with each other using any communication elements and/or protocols. An example of a communication system is denoted. Other communication elements may be provided.

FIG. 6 illustrates various timing diagrams 701-707 related to one of more of the method illustrated in the specification. Timing diagrams 701-705 are related to the Electric Vehicle with Optimized Regenerative Braking System. RB means regenerative braking, Eval means evaluation.

Timing diagrams 706-707 are related to Electric Vehicle Sensing System Error Mitigation.

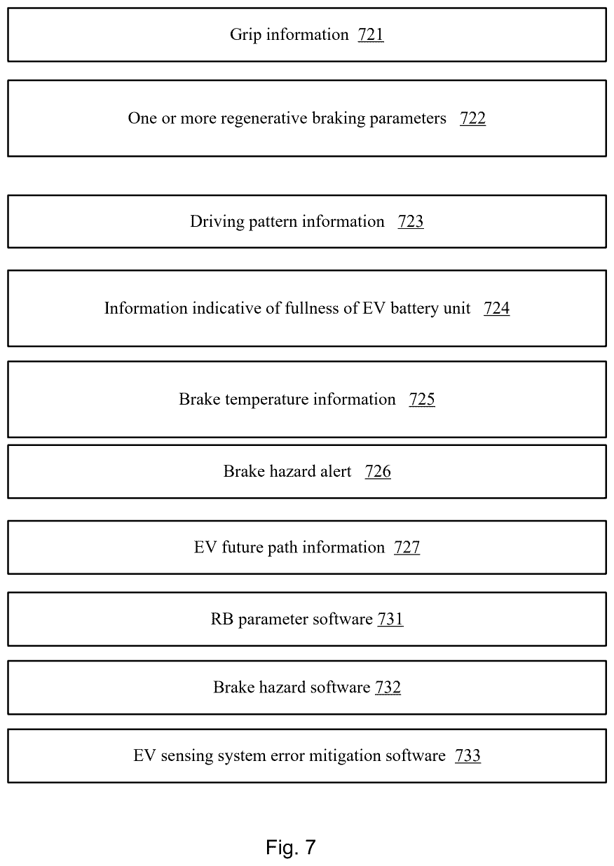

FIG. 7 illustrates examples of software and information elements stored in the one or more memory/storage units.

For the Electric Vehicle with Optimized Regenerative Braking System
a. Grip information 721.
b. One or more regenerative braking parameters 722 (regenerative braking parameter, additional regenerative braking parameter).
c. Driving pattern information 723.
d. RB parameter software 731.

For the Hazard detection in relation to an electric vehicle braking system:
a. Information indicative of fullness of electric vehicle (EV) battery unit 724.
b. Brake temperature information 725.
c. Brake hazard alert 726.
d. Brake hazard software 732.

For the Electric Vehicle Sensing System Error Mitigation:
a. Grip information 721.
b. One or more regenerative braking parameters 722.
c. EV future path information 727.
d. EV sensing system error mitigation software 733.

In the foregoing detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using microelectronics and/or optical components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference to a method should be applied mutatis mutandis to a device or system capable of executing the method and/or to a non-transitory computer readable medium that stores instructions for executing the method.

Any reference to a system or device should be applied mutatis mutandis to a method that may be executed by the system, and/or may be applied mutatis mutandis to non-transitory computer readable medium that stores instructions executable by the system.

Any reference to a non-transitory computer readable medium should be applied mutatis mutandis to a device or system capable of executing instructions stored in the non-transitory computer readable medium and/or may be applied mutatis mutandis to a method for executing the instructions.

Any reference to comprising or having or including or includes or include or have should be applied mutatis mutandis to consisting or consists.

Any reference to comprising or having or including or includes or include or have should be applied mutatis mutandis to consisting essentially of.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for adaptive regenerative braking, the method comprises:
(a) obtaining grip information that is indicative of a grip associated with an electrical vehicle during a grip evaluation period; wherein the regerenative braking parameter is a value of a torque to be applied on front wheels of the vehicle during the regenerative braking;
(b) determining, based on the grip information, a value of a regenerative braking parameter;
(c) sending to a regenerative braking unit of the vehicle an instruction to apply during a portion of the regenerative braking period, the regenerative braking parameter;
(d) applying, during the generative braking, the torque having the determined value on the front wheels of the electrical vehicle;
wherein steps (a)-(b) are preceded by:
(i) obtaining an estimate that an object is in the future path of a vehicle;
(ii) performing an initial regenerative braking session with a specific initial value for the regenerative braking parameter;
(iii) obtaining, during the initial regenerative braking session, initial grip information indicative of a grip associated with the electrical vehicle during the initial regenerative braking session; and
(iv) determining, based on the initial grip information, whether to postpone the continuation of regenerative braking until the estimate is validated; and
(v) jumping to step following a successful validation of the presence of the object in the future path of the vehicle.

2. (canceled)

3. The method according to claim 1, further comprising:
obtaining additional grip information that is indicative of the grip associated with the electrical vehicle during an additional grip evaluation period;
determining, based on the additional grip information, an additional value of the regenerative braking parameter; and
sending to the regenerative braking unit an instruction to apply during an additional portion of the regenerative braking period, the additional regenerative braking parameter.

4. The method according to claim 3, further comprising applying, during the portion of the regenerative braking period, the regenerative braking parameter.

5. The method according to claim 3, wherein the grip evaluation period starts (i) at a beginning of the adaptive regenerative braking or (ii) following the beginning of the adaptive regenerative braking and in timing proximity to the beginning of the adaptive regenerative braking.

6. The method according to claim 3, wherein the grip evaluation period ends before a beginning of the adaptive regenerative braking.

7. The method according to claim 3, wherein the grip information is generated based on radial speeds of regenerative braking wheels of an electric vehicle and on radial speeds of non-regenerative braking wheels of the electric vehicle.

8. The method according to claim 3, comprising obtaining driving pattern information indicative of an expected driving pattern of at least one of the electrical vehicle and a driver of the electrical vehicle, and wherein the determining of the value of the regenerative braking parameter is also based on the driving pattern information.

9. A non-transitory computer readable medium for adaptive regenerative braking, the non-transitory computer readable medium stores instructions executable by a processor for:
(a) obtaining grip information that is indicative of a grip associated with an electrical vehicle during a grip evaluation period;
(b) determining, based on the grip information, a value of a regenerative braking parameter; wherein the regerenative braking parameter is a value of a torque to be applied on front wheels of the vehicle during the regenerative braking;
(c) sending to a regenerative braking unit of the vehicle an instruction to apply during a portion of the regenerative braking period, the regenerative braking parameter;
(d) applying, during the generative braking, the torque having the determined value on the front wheels of the electrical vehicle;
wherein steps (a)-(b) are preceded by:
(i) obtaining an estimate that an object is in the future path of a vehicle;
(ii) performing an initial regenerative braking session with a specific initial value for the regenerative braking parameter;
(iii) obtaining, during the initial regenerative braking session, initial grip information indicative of a grip associated with the electrical vehicle during the initial regenerative braking session; and
(iv) determining, based on the initial grip information, whether to postpone the continuation of regenerative braking until the estimate is validated; and
(v) jumping to step following a successful validation of the presence of the object in the future path of the vehicle.

10. (canceled)

11. The non-transitory computer readable medium according to claim 9, that further stores instructions for:
obtaining additional grip information that is indicative of the grip associated with the electrical vehicle during an additional grip evaluation period;
determining, based on the additional grip information, an additional value of the regenerative braking parameter; and
sending to the regenerative braking unit an instruction to apply during an additional portion of the regenerative braking period, the additional regenerative braking parameter.

12. The non-transitory computer readable medium according to claim 11, that further stores instructions for applying, during the portion of the regenerative braking period, the regenerative braking parameter.

13. The non-transitory computer readable medium according to claim 11, wherein the grip evaluation period starts (i) at a beginning of the adaptive regenerative braking or (ii) following the beginning of the adaptive regenerative braking and in timing proximity to the beginning of the adaptive regenerative braking.

14. The non-transitory computer readable medium according to claim 11, wherein the grip evaluation period ends before a beginning of the adaptive regenerative braking.

15. The non-transitory computer readable medium according to claim 11, wherein the grip information is generated based on radial speeds of regenerative braking wheels of an electric vehicle and on radial speeds of non-regenerative braking wheels of the electric vehicle.

16. The non-transitory computer readable medium according to claim 11, that stores instructions for obtaining driving pattern information indicative of an expected driving pattern of at least one of the electrical vehicle and a driver of the electrical vehicle, and wherein the determining of the value of the regenerative braking parameter is also based on the driving pattern information.

17. A computerized system for adaptive regenerative braking, the computerized system comprises:
a processing circuit that is configured to:
(a) obtain grip information that is indicative of a grip associated with an electrical vehicle during a grip evaluation period;
(b) determine, based on the grip information, a value of a regenerative braking parameter; wherein the regerenative braking parameter is a value of a torque to be applied on front wheels of the vehicle during the regenerative braking;
(c) send to a regenerative braking unit of the vehicle an instruction to apply during a portion of the regenerative braking period, the regenerative braking parameter;
(i) obtaining an estimate that an object is in the future path of a vehicle;
(ii) perform an initial regenerative braking session with a specific initial value for the regenerative braking parameter;
(iii) obtain, during the initial regenerative braking session, initial grip information indicative of a grip associated with the electrical vehicle during the initial regenerative braking session; and
(iv) determine, based on the initial grip information, whether to postpone the continuation of regenerative braking until the estimate is validated; and
(v) jump to step (a) following a successful validation of the presence of the object in the future path of the vehicle. and
a unit that is configured to applying, during the generative braking, the torque having the determined value on the front wheels of the electrical vehicle.

18. (canceled)

19. The computerized system according to claim 17, wherein the processing circuit is further configured to (a) obtain additional grip information that is indicative of the grip associated with the electrical vehicle during an additional grip evaluation period, (b) determining, based on the additional grip information, an additional value of the regenerative braking parameter; and (c) send to the regenerative braking unit of the vehicle an instruction to apply during an addition portion of the regenerative braking period, the additional regenerative braking parameter.

20. The computerized system according to claim 19, further comprising the regenerative braking unit, wherein the regenerative braking unit is configured to apply the regenerative braking parameter, during the portion of the regenerative braking period.
